(19) United States
(12) Patent Application Publication
(10) Pub. No.: US 2008/0122154 A1
(43) Pub. Date: May 29, 2008

(54) Workpiece guiding device for guiding a workpiece fed on a workbench of a working machine

(76) Inventor: Hui-Chuan Liao, Ta-Li City (TW)

Correspondence Address: BIRCH STEWART KOLASCH & BIRCH, PO BOX 747, FALLS CHURCH, VA, 22040-0747, US

(21) Appl. No.: 11/713,040

(22) Filed: Mar. 2, 2007

(30) Foreign Application Priority Data
Nov. 28, 2006 (CN) 200620159948.2

(51) Int. Cl. B23Q 3/18

(52) U.S. Cl. 269/59

(57) ABSTRACT

A workpiece guiding device for guiding a workpiece fed on a workbench of a working machine, such as a wood planing machine, includes a seat unit, an elongate guiding member having an abutment major surface to be in sliding contact with the workpiece, and a connecting major surface with an anchoring mount, a journal shaft disposed on the anchoring mount, and left and right clamping members disposed to be forced to abut against lateral surfaces of the seat unit and the anchoring mount to thereby hold the guiding member firmly on the workbench. The journal shaft is turnable on the clamping members to permit the guiding member to turn about a rotating axis. An angular position presetting member has a coupling portion rotated with the journal shaft, and an anchoring portion offset from the rotating axis. A retaining unit is disposed to releasably retain the anchoring portion on the clamping member.

### CROSS-REFERENCE TO RELATED APPLICATION

This application claims priority of Chinese patent Application No. 200620159948.2, filed on Nov. 28, 2006.

### BACKGROUND OF THE INVENTION

1. Field of the Invention

This invention relates to a working machine, such as a wood planing machine, more particularly to a workpiece guiding device for guiding a workpiece fed on a workbench of the working machine.

2. Description of the Related Art

Referring to FIGS. 1 and 2, a conventional wood planing machine 10 as disclosed in U.S. Pat. No. 6,478,060 to the applicant, the entire content of which is hereby incorporated herein by reference, includes a workpiece-guiding plate 16 disposed on a workbench 14,15 for guiding a workpiece fed along a feeding route in a longitudinal direction transverse to a cutter 13. A mounting block 18 is movably mounted on a fixed base 17 to be close to or away from the cutter 13. A seat 21 is disposed on the mounting block 18 to form left and right abutment surfaces 211,212. A stem 231 is secured to the seat 21, and has left and right stem ends 2311,2312 which extend outboard to the left and right abutment surfaces 211,212, respectively. An anchoring mount 22 is secured to the workpiece-guiding plate 16, and forms left and right clamped surfaces 221,222. A journal shaft 232 is secured to the anchoring mount 22, and has left and right journal ends 2321,2322 extending outboard to the left and right clamped surface 221,222, respectively. Elongate left and right clamping members 233,234 respectively have left and right clamping surfaces which are brought to abut against the left abutment and clamped surfaces 211,221 and the right abutment and clamped surfaces 212,222, respectively. The left and right clamping members 233,234 are disposed to sleeve on the left stem and journal ends 2311,2321 and the right stem and journal ends 2312,2322, respectively, such that the journal shaft 232 is turnable relative to the left and right clamping members 233,234 to permit the workpiece-guiding plate 16 to turn with respect to the workbench 14,15. A tightening rod 241 has a threaded segment 243 which engages threadedly a tapped hole in the left clamping member 233, and a non-threaded segment 244 which extends through a hole in the right clamping member 234 and which is connected to an operated lever 242 such that rotation of the tightening rod 241 results in displacement of the left clamping member 233 to be close to or away from the right clamping member 234.

Referring to FIG. 3, when the workpiece-guiding plate 16 is in a retained position, the left and right clamping members 233,234 abut against and clamp the seat 21 and the anchoring mount 22 so as to prevent rotation of the anchoring mount 22. Referring to FIG. 4, during adjustment of the angular position of the plate 16, the tightening rod 241 is rotated through the operated lever 242 to cause the left clamping member 233 to move away from the right clamping member 234 so as to release the anchoring mount 22 and the seat 21 to thereby permit rotation of the anchoring mount 22 and the plate 16. When the angle adjustment of the plate 16 is completed, the tightening rod 241 is rotated to move the left and right clamping members 233,234 so as to tighten the seat 21 and the anchoring mount 22.

However, during the angle adjustment of the plate 16, an angle correcting device (not shown) placed between the plate 16 and the workbench 14,15 is needed so as to enable the plate 16 to be adjusted to the predetermined angular position. Hence, the angle adjustment is inconvenient to conduct and is not precise. Moreover, once the operated lever 242 is hit inadvertently to cause rotation of the tightening rod 241, the plate 16 may be turned undesirably.

### SUMMARY OF THE INVENTION

The object of the present invention is to provide a workpiece guiding device which can be adjusted conveniently and precisely, and which can retain a guiding member firmly in position on a workbench.

According to this invention, the workpiece guiding device includes: a mounting block which is disposed to be movable in a transverse direction transverse to a feeding route of a workpiece on a workbench of a working machine, and which has a front end that is proximate to the feeding route; a seat unit disposed to extend uprightly from the front end of the mounting block to form left and right abutment surfaces opposite to each other in a longitudinal direction parallel to the feeding route; left and right stems disposed to extend respectively from the left and right abutment surfaces and away from each other; an elongate guiding member which includes an abutment major surface that extends in the longitudinal direction, and that is adapted to be in sliding contact with the fed workpiece, and a connecting major surface opposite to the abutment major surface in the transverse direction; an anchoring mount disposed to extend from the connecting major surface in the transverse direction to form left and right clamped surfaces that are opposite to each other in the longitudinal direction; left and right journals which are disposed to extend respectively from the left and right clamped surfaces in the longitudinal direction; left and right clamping members which are respectively elongated in the transverse direction, and which respectively have left clamping and depressed surfaces opposite to each other in the longitudinal direction, and right clamping and depressed surfaces opposite to each other in the longitudinal direction such that the left and right clamping surfaces are brought to abut against the left abutment and clamped surfaces and the right abutment and clamped surfaces, respectively, each of the left and right clamping members having a through hole which is configured to receive a corresponding one of the left and right stems, and an annular bearing surface which is configured to be sleeved on a corresponding one the left and right journals such that the left and right journals are turnable on the left and right annular bearing surfaces to permit the elongate guiding member to turn between first and second positions that are angularly displaced from each other about a rotating axis defined by the left and right annular bearing surfaces; a tightening member disposed to force the left and right clamping surfaces to abut against the left abutment and clamped surfaces and the right abutment and clamped surfaces, respectively, so as to generate a friction force that prevents turning of the left and right journals, thereby holding the elongate guiding member firmly in a selected one of the first and second positions; an angular position presetting member including a coupling portion which is disposed outboard to one of the left and right depressed surfaces, and which is disposed to be rotated with one of the left and right journals about the rotating axis, and an anchoring portion which is offset from the rotating axis, and which is turnable about the rotating axis between first and second predetermined positions; and a retaining unit which is disposed to be releasable in the longitudinal direction, and which is disposed to releasably retain the anchoring portion on the one of the left and right depressed surfaces so as to prevent the anchoring portion from turning about the rotating axis, thereby holding the anchoring portion firmly in a selected one of the first and second predetermined positions.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a wood planing machine of U.S. Pat. No. 6,478,060;

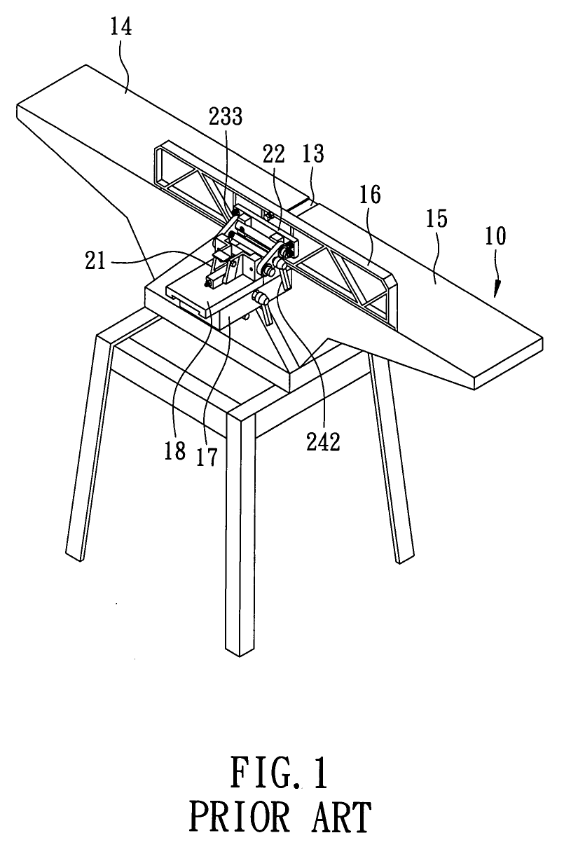

FIG. 2 is an exploded perspective view of a workpiece guiding device of the wood planing machine of U.S. Pat. No. 6,478,060;

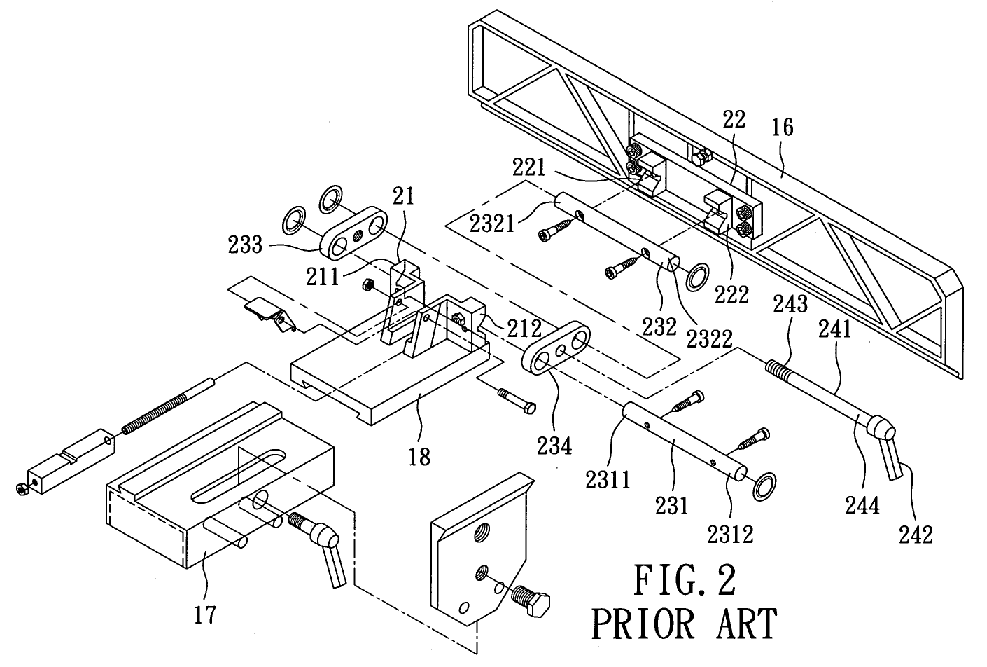

FIG. 3 is a fragmentary sectional view of the wood planing machine of U.S. Pat. No. 6,478,060, showing a workpiece-guiding plate in a locked position;

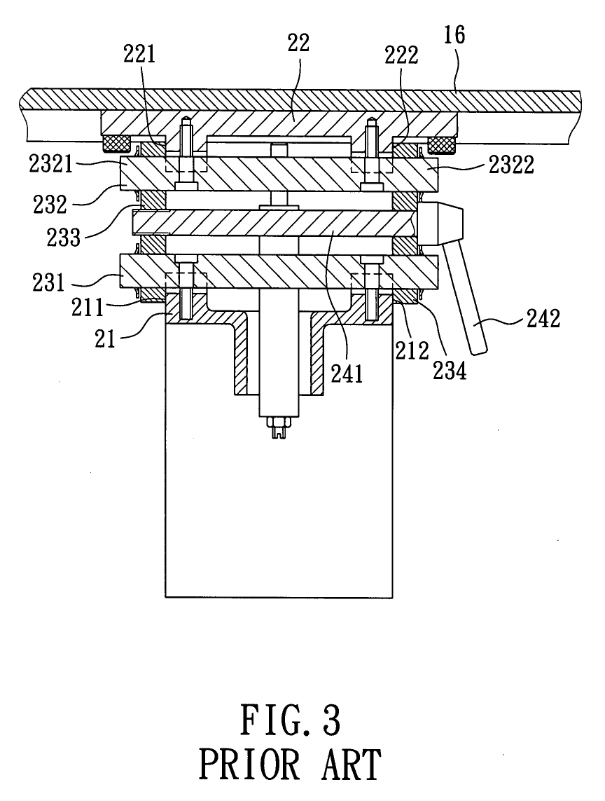

FIG. 4 is a view similar to FIG. 3, but showing the workpiece-guiding plate in an unlocked position;

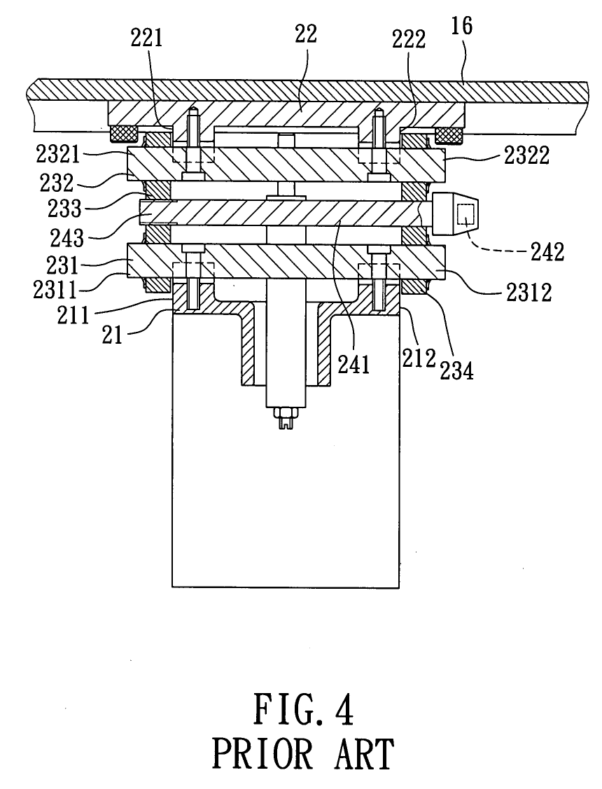

FIG. 5 is a perspective view of the preferred embodiment of a workpiece guiding device according to this invention when mounted on a workbench of a working machine;

FIG. 6 is an exploded perspective view of the preferred embodiment;

FIG. 7 is a fragmentary perspective view of the preferred embodiment;

FIG. 8 is a fragmentary sectional view of the preferred embodiment, but showing a retaining unit in a locking state; and

FIG. 9 is a view similar to FIG. 8, showing the retaining unit in an unlocking state.

### DETAILED DESCRIPTION OF THE PREFERRED EMBODIMENT

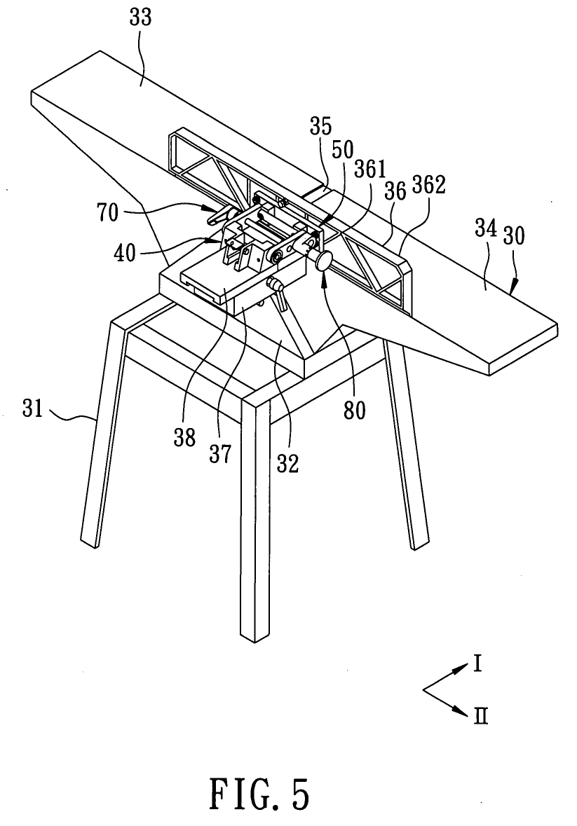

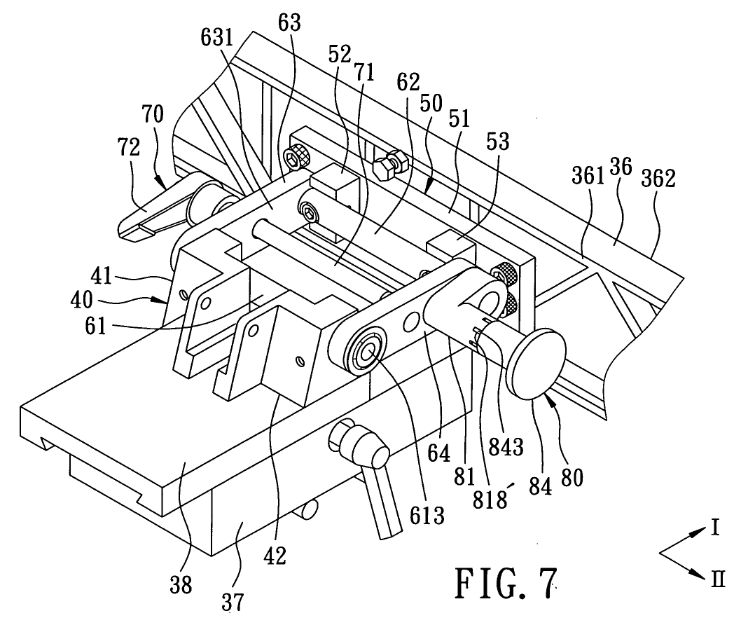

Referring to FIGS. 5 to 7, the preferred embodiment of a workpiece guiding device according to the present invention is shown to be mounted on a working machine, such as a wood planing machine 30, for guiding a workpiece (not shown) fed along a feeding route in a longitudinal direction (II) on a workbench 34,35. The wood planing machine 30, as a conventional wood planing machine, includes a machine frame 31, a base 32 securely mounted on a top of the machine frame 31, and a cutter 35 disposed to project upwardly of the workbench 34,35. The workpiece guiding device in this embodiment is shown to comprise a mounting block 38, a seat unit 40, a coupling shaft 61, an elongate guiding member 36, an anchoring mount 50, a journal shaft 62, left and right clamping members 63,64, a tightening member 70, an angular position presetting member 81, and a retaining unit 80.

The mounting block 38 is mounted on and movable relative to a fixed block 37 on the base 32 in a direction (I) transverse to the longitudinal direction (II), and has a front end proximate to the feeding route of the workpiece.

The seat unit 40 has left and right seats 41,42 which are disposed to extend uprightly from the front end of the mounting block 38 and which respectively form left and right abutment surfaces 413,423 that are opposite to each other in the longitudinal direction (II).

The coupling shaft 61 has a larger middle stem 611 which is secured to the left and right seats 41,42 by means of two screws 65, and smaller left and right stems 612,613 which are disposed to extend respectively from the left and right abutment surfaces 413,423 and away from each other in the longitudinal direction (II).

The guiding member 36 is in the form of an elongate plate, and includes an abutment major surface 362 which extends in the longitudinal direction (II) and which is adapted to be in sliding contact with the fed workpiece, and a connecting major surface 361 opposite to the abutment major surface 362 in the transverse direction (I).

The anchoring mount 50 is disposed to extend from the connecting major surface 361 in the transverse direction (I), and includes a mounting block 51 fixed on the connecting major surface 361, and left and right coupling blocks 52,53 which are fixed on the mounting block 51 and which respectively form left and right clamped surfaces 522,532 that are opposite to each other in the longitudinal direction (II).

The journal shaft 62 has a larger middle stem 621 which is secured to the left and right coupling blocks 52,53 by means of two screws 66, and smaller left and right journals 622,623 which are disposed to respectively extend from the left and right clamped surfaces 522,532 in the longitudinal direction (II).

The left and right clamping members 63,64 are elongated in the transverse direction (I), and respectively have left clamping and depressed surfaces 631,632 opposite to each other in the longitudinal direction (II), and right clamping and depressed surfaces 641,642 opposite to each other in the longitudinal direction (II). The left and right clamping surfaces 631,641 are brought to abut against the left abutment and clamped surfaces 413,522 and the right abutment and clamped surfaces 423,532, respectively. Each of the left and right clamping members 63,64 has a through hole 633,643 which is configured to receive a corresponding one of the left and right stems 612,613, and an annular bearing surface 634,644 which is configured to be sleeved on a corresponding one of the left and right journals 622,623 such that the journal shaft 62 is turnable on the left and right annular bearing surfaces 634,644 to permit the elongate guiding member 36 to turn about a rotating axis defined by the left and right annular bearing surfaces 634,644. The left and right clamping members 63,64 further have a passage 635 and a tapped hole 645, respectively, extending in the longitudinal direction (II) and aligned with each other. Furthermore, the right depressed surface 642 of the right clamping member 64 has a plurality of positioning holes 646,646′,646″ which are angularly displaced from one another about the rotating axis to correspond to first, second, and third positions of the guiding member 36, such as included angles of 45, 90, and 135 degrees with respect to the workbench 33,34.

The tightening member 70 includes a tightening rod 71, a washer 73, and an operated lever 72. The tightening rod 71 has a threaded segment 711 which engages threadedly the tapped hole 645 in the right clamping member 64, and a non-threaded segment 712 which extends through the passage 635 in the left clamping member 63 and which terminates at a coupled end disposed outboard to the left depressed surface 632. The washer 73 is sleeved on the coupled end of the tightening rod 71. The operated lever 72 has a pressing end which cooperates with the coupled end to form an abutment shoulder 721 that confronts the left depressed surface 632, and an operated end 722 which is configured to rotate the threaded segment 711 relative to the right clamping member 64 so as to force the washer 73 to depress the left depressed surface 632 by virtue of friction engagement between the abutment shoulder 721 and the washer 73 to thereby bring the right clamping member 64 closer to the left clamping member 63 in the longitudinal direction (II). Thus, the left and right clamping surfaces 631,641 are forced to abut against the left abutment and clamped surfaces 413,522 and the right abutment and clamped surfaces 423,532, respectively, so as to generate a friction force that prevents turning of the journal shaft 62, thereby holding the guiding member 36 firmly in a selected one of the first, second and third positions.

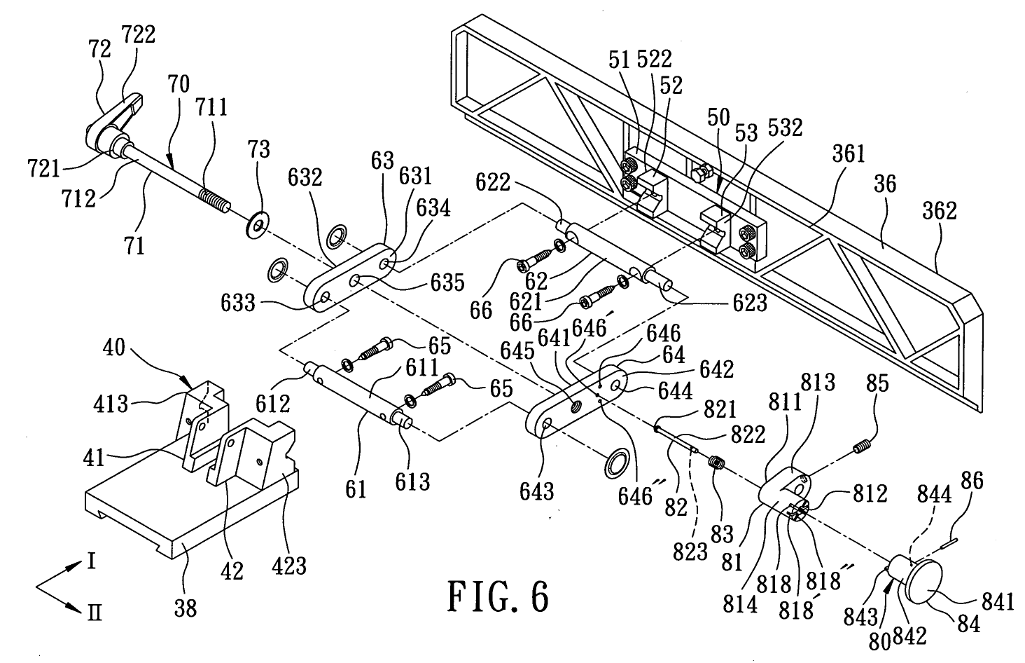

With reference to FIGS. 6 to 8, the angular position presetting member 81 includes a coupling portion 813 which is disposed outboard to the right depressed surface 642 of the right clamping member 64, which is configured to be sleeved on the right journal 623, and which is secured to the right journal 623 by means of a screw fastener 85 such that the coupling portion 813 is rotated with the journal shaft 62 about the rotating axis, and an anchoring portion 814 which is offset from the rotating axis, and which is turnable about the rotating axis. The anchoring portion 814 has an abutting surface 811 which is disposed to abut against the right depressed surface 642 of the right clamping member 64, and a coupled surface 812 which is opposite to the abutting surface 811 in the longitudinal direction (II) and which has a communicating slot 817 that extends through the abutting surface 811 to be communicated with a selected one of the positioning holes 646,646′,646″. The communicating slot 817 is in the form of a stepped hole having a shoulder 819 therein. Moreover, the coupled surface 812 of the anchoring portion 814 has a plurality of splined holes 818,818′, 818″ in first, second and third predetermined positions that correspond to the first, second and third positions of the guiding member 36, respectively.

The retaining unit 80 includes a latch 82, a biasing member 83, and an actuating member 84.

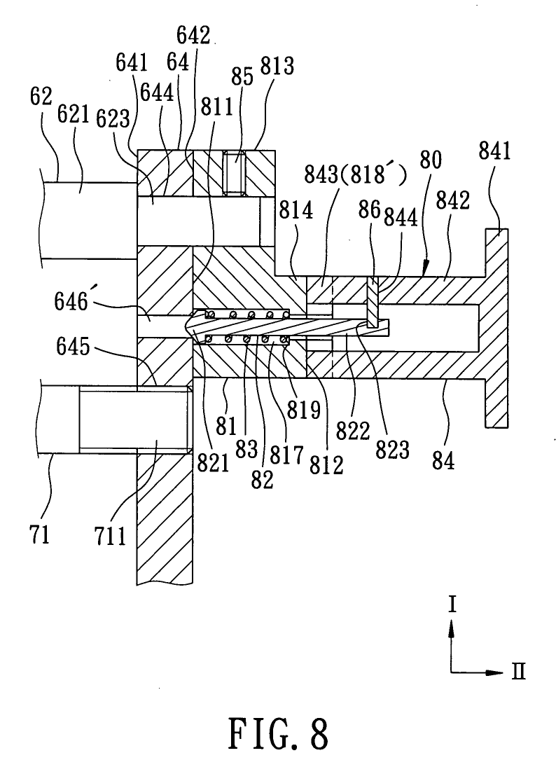

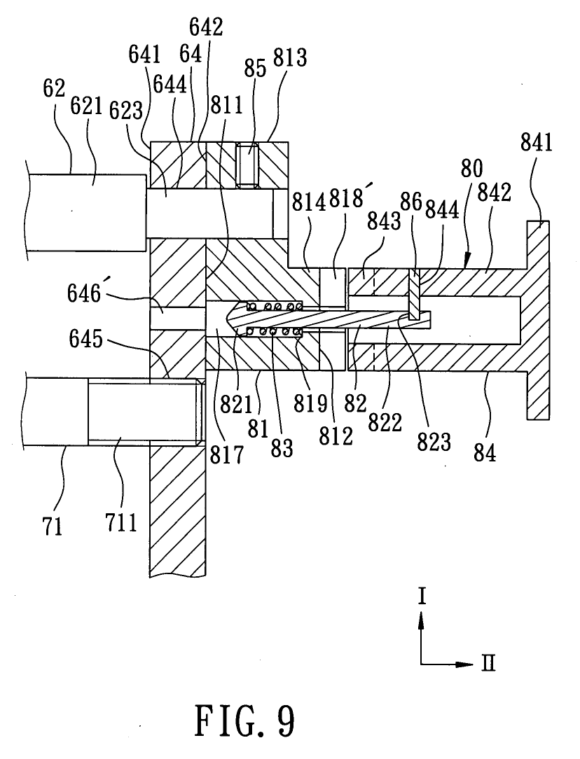

The latch 82 is received in the communicating slot 817, and has an enlarged latch end 821 which is movable relative to the anchoring portion 814 between a locking position, as shown in FIG. 8, where the latch end 821 engages the selected one of the positioning holes 646,646′,646″ so as to guard against turning of the anchoring portion 814 to thereby hold the guiding member in the selected one of the first, second and third positions, and an unlocking position, as shown in FIG. 9, where the latch end 821 is disengaged from the selected one of the positioning holes 646, 646′,646″, and an operated end 822 which is disposed to extend outwardly of the coupled surface 812 so as to be operable manually.

The biasing member 83 is received in the communicating slot 817, and abuts against the shoulder 819 and the latch end 821 so as to bias the latch end 821 to the locking position.

The actuating member 84 has a sleeve 842 which surrounds and which is coupled to the operated end 822 of the latch 82 by means of a pin 86 that extends through a radial hole 844 in the sleeve 842 to engage a radial hole 823 in the operated end 822, and an enlarged head 841 such that when the enlarged head 841 is pulled away from the coupled surface 812, the latch end 821 is displaced to the unlocking position against the biasing action of the biasing member 83. The sleeve 842 has a spline 843 to be in spline engagement with a selected one of the splined holes 818,818′,818″ to prevent rotation of the angular position presetting member 81 relative to the right clamping member 64 so as to ensure retention of the latch end 821 in the locking position.

As shown in FIG. 8, when the wood planing machine is in use, the guiding member 36 is retained with respect to the workbench 33,34 at the first position, e.g., at an included angle of 90 degrees, where the left and right clamping surfaces 631,641 abut against and clamp the left abutment and clamped surfaces 413,522 and the right abutment and clamped surfaces 423,532, where the latch end 821 of the latch 82 is inserted into the selected positioning hole, such as the positioning hole 646′, and where the spline 843 is engaged with the selected splined hole, such as the splined hole 818′.

As shown in FIG. 9, when it is desired to adjust the guiding member 36 to the second position, e.g., at an included angle of 45 degrees with respect to the workbench 33,34, the operated lever 72 is operated to rotate the tightening rod 71 so as to move the right clamping member 64 away from the left clamping member 63. The enlarged head 841 is pulled to move the latch end 821 to the unlocking position while the spline 843 is disengaged from the splined hole 818′. Hence, the guiding member 36, as well as the angular position presetting member 81, is permitted to rotate about the rotating axis and can be adjusted to the second position. Subsequently, the enlarged head 841 is released to permit the latch end 821 to move to the locking position by virtue of the biasing action of the biasing member 83 so as to engage the positioning hole 818, and to permit the spline 843 to engage the corresponding splined hole 818. Finally, the operated lever 72 is operated to rotate the tightening rod 71 so as to bring the left and right clamping members 63,64 to tighten the seat unit 40 and the anchoring mount 50. In this invention, since the positioning hole 646,646′,646″ and the splined holes 818,818′,818″ are preset to correspond to the included angles of the guiding member 36 relative to the workbench 33,34, the angle adjustment of the guiding member 36 is easy and precise.

As illustrated, by means of the engagement of the latch 82 with a selected one of the positioning holes 646,646′,646″ and the engagement of the spline 843 with the splined holes 818,818′,818″, the guiding member 36 can be adjusted to a predetermined angular position without the need to use an angle correcting device (not shown). Moreover, by means of the retaining unit 80, the anchoring portion 814 of the angular position presetting member 81 is retained on the right clamping member 64 so as to prevent the anchoring portion 814 from turning about the rotating axis, thereby hold the anchoring portion 814 firmly in the selected predetermined position. Hence, even when the operated lever 72 is hit inadvertently to rotate the tightening rod 71, the guiding member 36 can be retained in place.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A workpiece guiding device for guiding a workpiece fed along a feeding route in a longitudinal direction on a workbench of a working machine, said workpiece guiding device comprising:
a mounting block which is disposed to be movable in a direction transverse to the longitudinal direction, and which has a front end that is proximate to the feeding route;
a seat unit disposed to extend uprightly from said front end of said mounting block so as to form left and right abutment surfaces that are opposite to each other in the longitudinal direction;
left and right stems disposed to extend respectively from said left and right abutment surfaces and away from each other;
an elongate guiding member which includes an abutment major surface that extends in the longitudinal direction, and that is adapted to be in sliding contact with the fed workpiece, and a connecting major surface opposite to said abutment major surface in the transverse direction;
an anchoring mount disposed to extend from said connecting major surface in the transverse direction to form left and right clamped surfaces that are opposite to each other in the longitudinal direction;
left and right journals which are disposed to extend respectively from said left and right clamped surfaces in the longitudinal direction;
left and right clamping members which are respectively elongated in the transverse direction, and which respectively have left clamping and depressed surfaces opposite to each other in the longitudinal direction, and right clamping and depressed surfaces opposite to each other in the longitudinal direction such that said left and right clamping surfaces are brought to abut against said left abutment and clamped surfaces and said right abutment and clamped surfaces, respectively, each of said left and right clamping members having a through hole which is configured to receive a corresponding one of said left and right stems, and an annular bearing surface which is configured to be sleeved on a corresponding one of said left and right journals such that said left and right journals are turnable on said left and right annular bearing surfaces to permit said elongate guiding member to turn between first and second positions that are angularly displaced from each other about a rotating axis defined by said left and right annular bearing surfaces;
a tightening member disposed to force said left and right clamping surfaces to abut against said left abutment and clamped surfaces and said right abutment and clamped surfaces, respectively, so as to generate a friction force that prevents turning of said left and right journals to thereby hold said elongate guiding member firmly in a selected one of the first and second positions;
an angular position presetting member including a coupling portion which is disposed outboard to one of said left and right depressed surfaces, and which is disposed to be rotated with one of said left and right journals about the rotating axis, and an anchoring portion which is offset from the rotating axis, and which is turnable about the rotating axis between first and second predetermined positions; and
a retaining unit which is disposed to be releasable in the longitudinal direction, and which is disposed to releasably retain said anchoring portion on said one of said left and right depressed surfaces so as to prevent said anchoring portion from turning about the rotating axis, thereby holding said anchoring portion firmly in a selected one of the first and second predetermined positions.

2. The workpiece guiding device of claim 1, wherein said right depressed surface of said right clamping member has a plurality of positioning holes which are angularly displaced from each other about the rotating axis to correspond to the first and second positions, respectively,
said anchoring portion of said angular position presetting member having an abutting surface which is disposed to abut against said right depressed surface, and a coupled surface which is opposite to said abutting surface in the longitudinal direction and which has a communicating slot that extends through said abutting surface to be communicated with a selected one of said positioning holes,
said retaining unit including a latch which is received in said communicating slot, and which has a latch end that is movable relative to said anchoring portion between a locking position, where said latch end engages the selected one of said positioning holes so as to guard against turning of said anchoring portion to thereby hold said elongate guiding member in the selected one of the first and second positions, and an unlocking position, where said latch end is disengaged from the selected one of said positioning holes, and an operated end that is disposed to extend outwardly of said coupled surface so as to be operable manually.

3. The workpiece guiding device of claim 2, wherein said retaining unit further includes an actuating member which is coupled to said operated end of said latch such that when said actuating member is pulled away from said coupled surface, said latch end is displaced to the unlocking position, and which is disposed to be in spline engagement with said coupled surface of said anchoring portion so as to ensure retention of said latch end in the locking position.

4. The workpiece guiding device of claim 3, wherein said coupling portion is configured to be sleeved on said right journal, said workpiece guiding device further comprising a screw fastener which is disposed to fasten said right journal to said coupling portion.

5. The workpiece guiding device of claim 3, wherein said retaining unit further includes a biasing member which is received in said communicating slot and which is disposed to bias said latch end to the locking position.

6. The workpiece guiding device of claim 1, wherein said left and right clamping members respectively have a passage and a tapped hole extending in the longitudinal direction and aligned with each other,
said tightening member including
a tightening rod which has a threaded segment that engages threadedly said tapped hole, and a non-threaded segment that extends through said passage and that terminates at a coupled end disposed outboard to said left depressed surface,
a washer sleeved on said coupled end of said tightening rod, and
an operated lever having a pressing end which cooperates with said coupled end to form an abutment shoulder that confronts said left depressed surface, and an operated end which is configured to rotate said threaded segment relative to said right clamping member so as to force said washer to depress said left depressed surface by virtue of friction engagement between said abutment shoulder and said washer, thereby bringing said right clamping member closer to said left clamping member in the longitudinal direction.
